(19) United States
(12) Patent Application Publication
(10) Pub. No.: US 2025/0350951 A1
(43) Pub. Date: Nov. 13, 2025

(54) SAFE UNMANNED AERIAL VEHICLE HIVE COMMUNICATION AND DATA TRANSMISSION

(71) Applicant: Teal Drones, Inc., Holladay, UT (US)

(72) Inventors: George Michael Matus, Salt Lake City, UT (US); Manuel Rodrigo Lopez Morales, East Palo Alto, CA (US)

(21) Appl. No.: 17/465,622

(22) Filed: Sep. 2, 2021

Related U.S. Application Data
(60) Provisional application No. 63/074,372, filed on Sep. 3, 2020.

(51) Int. Cl. H04W 12/64; H04W 64/00

(52) U.S. Cl. CPC H04W 12/64; H04W 64/006

(57) ABSTRACT

An unmanned aerial vehicle (UAV) for collecting data and safe transmission of the collected data is configured to receive an instruction from a central server. The instruction includes one or more safe zones or one or more unsafe zones. The UAV is also configured to collect and transmit data to one or more nearby UAVs and/or the central server based on a command received from the central server. In response to determining a need for transmitting the collected data to one or more nearby UAVs and/or the central server, the UAV identifies a current location of itself and determines whether the current location is in a safe zone or an unsafe zone based on the instruction. In response to determining that the current location is not in a safe zone or is in an unsafe zone, the UAV prevents the collected data from being transmitted.

### CROSS-REFERENCE TO RELATED APPLICATION

This application claims the benefit of U.S. Provisional Application No. 63/074,372, filed Sep. 3, 2020, the entire contents of which are herein incorporated by reference.

### BACKGROUND

Unmanned aerial vehicles (UAVs) or drones have a variety of applications such as package delivery, recreational flight, and land surveying. Perhaps most importantly, however, are the applications that allow for aerial actions to be undertaken in dangerous airspace without the use of a human pilot. When flying dangerous missions using a drone, the pilot can be entirely removed from the cockpit and can command the aerial vehicle from a place of safety.

Some missions require the use of multiple UAVs to quickly cover more ground. In these circumstances, it is essential for drones on the mission (the hive) to be able to communicate findings between them. But communication and data transmission in airspace where a hive could be sent may need to be restricted such that the communication would need to be carefully transmitted to prevent the leak of intelligence gathered by the hive on the mission.

As such, there is a need for an increased ability for UAVs to communicate securely. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments herein are directed to safe UAV hive communication. In one embodiment, a hive of UAVs receives instruction from a central sever regarding the safe transmission of sensitive communication between UAVs in the hive. During deployment, the hive collects data to be transmitted throughout the hive. When data is identified for transmission, the UAV desiring to transfer the data uses the instruction from the central server to determine if the UAV is in a safe zone of communication. If the UAV determines it is not in a safe zone, the transmission is prevented.

In some embodiments, the instruction from the central server that is used by the UAVs of the hive to determine if the UAV is in a safe transmission zone includes a map with designated safe zones such as neutral or friendly airspace. In such embodiments, the UAV checks if it is in a safe zone as indicated by the map before transmitting any data. If the UAV determines it is not in one of the predetermined safe zones, the UAV prevents data transfer to another member of the hive.

In some embodiments, the instruction from the central server is not a map of predetermined zones but is a set of criteria to determine if the airspace occupied by the UAV is safe for transmission. The criteria could include but are not limited to using sensors to detect enemy aircraft, detecting enemy intelligence collection devices, or determining if the UAV is in enemy airspace based on borders or geographical landmarks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and detail through the use of the accompanying drawings.

FIG. 1 illustrates multiple UAVs connected to a central server to receive instructions for determining if the transmission of data is safe.

FIG. 2 illustrates multiple UAVs, receiving instructions from the central server.

FIG. 3 illustrates multiple UAVs collecting data in safe and unsafe zones.

FIG. 4 illustrates a UAV in a safe zone identifying information to be transmitted to another UAV and completing the transfer check process.

FIG. 5 illustrates a UAV in an unsafe zone identifying information to be transmitted to another UAV and preventing the completion of the transfer check process.

FIG. 6 illustrates a flow chart describing a method of identifying and preventing unsafe UAVs.

### DETAILED DESCRIPTION

Disclosed embodiments include unmanned aerial vehicle (UAV) systems for safe communication between UAVs in a hive. The term “unmanned aerial vehicles” or “UAV” will be used herein to refer to any type of aerial vehicle with no onboard human, whether operated manually by a human remotely or automatically by a flight program. For example, a UAV may be deployed in a hive on a mission to collect data in potentially unfriendly airspace. When a UAV has collected data to be shared with the rest of the hive, the UAV may first ensure it is in safe airspace before transmitting the collected data. Disclosed embodiments allow a UAV to determine if the current location of the UAV is in an unsafe transmission zone such that the UAV will not transmit data for fear of it being intercepted.

Additional or alternate embodiments may receive instruction from a central server about what constitutes a safe zone for transmission. Safe zones can be determined by the UAVs through the instructions passed to them by a central server. These instructions can include maps that have predetermined safe zones. If the instruction from the central server is a map with predetermined safe zones, the UAV begins the transmission process by checking the location of the UAV each time a transmission is attempted and compares it with the safe zones on the map. If the UAV is within an unsafe zone, the UAV does not perform any communication. In contrast, if the UAV is in a safe zone, the transmission is allowed to proceed.

In additional or alternative embodiments, the instruction from the central server includes a criteria list for the UAV to check each time a transmission is attempted. The criteria are used to dynamically determine whether the UAV is within a safe zone or an unsafe zone. For example, the criteria may include the UAV checking to see if there are people or equipment nearby that could intercept potentially sensitive data. The UAV may complete these checks using a variety of sensors and methods to identify potential interceptors. The sensors or methods may include image recognition that has been programmed to identify particular equipment, people, uniforms, etc. The sensors may also include, but are not limited to, infrared, sonar, global positioning systems, and radio antennas. For instance, the UAV may scan through radio frequencies to determine whether unexpected radio transmissions are detected. In the case that they are detected, the UAV may determine that it is in an unsafe zone because other parties may be present and using radio channels.

The criteria to determine whether the UAV is in a safe or an unsafe zone may also include the UAV determining the current location of the UAV and comparing it to a stored location list to determine if the UAV is currently in restricted airspace or the airspace of an adversary. If the UAV discovers one of the criteria for safe transmission is not met, the UAV halts the transmission attempt and prevents data from transmitting.

In at least one embodiment, a UAV determines if it is in a safe zone and can be permitted to transmit. Safe zones are locations, airspace, or a location on the ground, in which data can be transmitted without concern for an interception from an unintended or hostile recipient. Safe zones can be, but are not limited to, areas that are free from enemy personnel, enemy surveillance equipment, and data collectors that are not authorized to receive the data being transmitted. Safe zones can also be zones that are not hostile environments or restricted airspace. In contrast, an unsafe zone is a zone in which data transmission is in danger of being intercepted or overheard by unauthorized sources.

In additional or alternative embodiments, the central server may be a computer system that has provides previously programmed instructions to a hive of one or more UAV(s) to perform designated tasks. These tasks may include search and recovery of humans or downed UAVs or collection of potentially sensitive intelligence. The central server can create or simply transfer the instructions to the hive of UAVs, after which further instructions from the central server are not typically needed or provided. Additional embodiments may include the central server in the form of a computer, laptop, phone, or tablet being controlled by a human user. Those knowledgeable in the art can appreciate the additional electronic devices that could be configured to control a hive of UAVs through a single wired connection data transfer, wireless non-continuous network data transfer, or wireless continuous network data. That is, the UAVs may receive a one-time mission instruction while hardwired to the central server or may receive instructions remotely or a combination of the two instruction delivery methods.

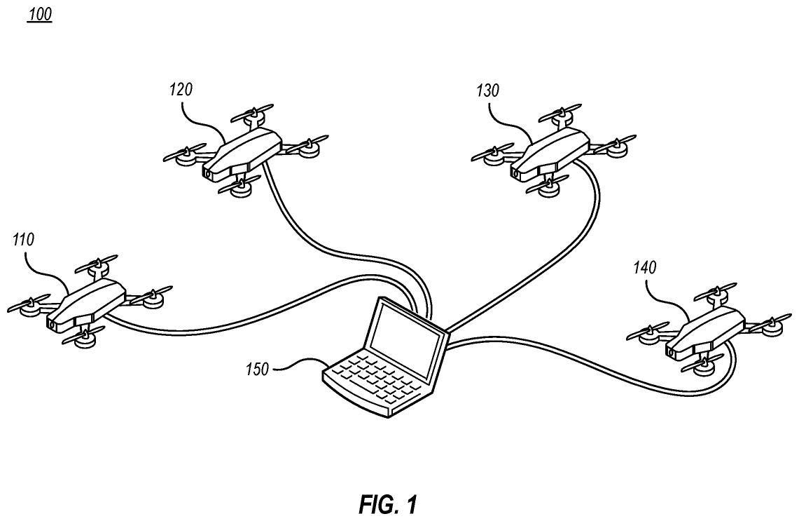

Referring to the figures, FIG. 1 illustrates a hive 100 of UAVs. The hive 100 in FIG. 1 includes several UAVs (110, 120, 130, and 140) and the central server 150. The one or more UAV(s) (110, 120, 130, and 140) receive instruction, “Z”, from the central server 150, the instruction allowing the one or more UAV(s) to determine locations that are safe for sensitive communication between the one or more UAV(s).

The UAVs 110, 120, 130, and 140 are configured to communicate with each other directly and/or indirectly via wireless communication interfaces and protocols. In some embodiments, each of the UAVs 110, 120, 130, and 140 is configured to communicate with each other directly. In some embodiments, the UAVs 110, 120, 130, and 140 form an ad hoc network, such that the UAVs 110, 120, 130, and 140 are configured to communicate with each other via one or more hops of the ad hoc network. Each hop is a communication link directly linking two nearby UAVs. In some embodiments, each of the UAVs 110, 120, 130, and 140 is configured to communicate with each other via the central server.

In at least one embodiment, the instruction “Z” contains data that the UAV uses to determine if the UAV is in a safe zone or an unsafe zone before transmitting any data to another UAV in the hive. The instruction data “Z” can be configured as a map including one or more geofences, indicating predetermined zones (e.g., safe zones and/or unsafe zones) and/or criteria that allow the UAV to dynamically determine whether it is safe or unsafe to communicate. In the case of instruction Z comprising a map, the predetermined zones segment off geographical coordinates based on whether they are safe for communication. For example, if data collection is occurring in both a country A and a country B, the map may designate to the UAV that transmission is allowed in country A and not in country B. Under this configuration, a UAV compares its current location (e.g., received from an onboard GPS chip) to the map within instruction Z.

If the UAV is not in a safe zone, the UAV prevents collected data from being transmitted. In at least one embodiment, when it is determined that the UAV is not in a safe zone or the UAV is in an unsafe zone, the UAV is caused to move into a safe zone or leave the unsafe zone before any collected data is transmitted. In response to determining that the UAV has moved into a safe zone or left the unsafe zone, the UAV is then caused to transmit the collected data.

In the case that the Z instruction comprises criteria, the instructions can be configured as a list of one or more criteria that the UAV uses to dynamically determine real-time if the UAV's current location is in a safe zone. In at least one embodiment, if a single criterion on the list raises a flag, such that it indicates the UAV is not in a safe zone, the UAV does not allow transmission of data.

In some embodiments, the one or more criteria may further include (but are not limited to) (1) one or more time intervals within which at least one of the safe zone or unsafe zone is safe or unsafe, (2) one or more objects when detected, indicating at least one of the safe zone or unsafe zone is safe or unsafe, and/or (3) a distance to ground or a landmark with which at least one of the safe zone or unsafe zone is safe or unsafe.

In some embodiments, the UAV includes a list of sensors configured to observe the nearby areas and determine whether one or more of the criteria are met. For example, some criteria may require no unauthorized humans or devices within a geographic area. In such an area, when the UAV detects a human, the UAV determines that it is in an unsafe zone. Additional criteria may include a time of day, within a predetermined distance from a person, a city or in a mountain range, etc., or potential signal interference.

The embodiment illustrated in FIG. 1 shows the central server as a laptop computer. It should be appreciated that the central server can be configured by any computing device that can control the hive, including but not limited to, a laptop, desktop, phone, or tablet device. The central server can be an interface that allows a human to control or instruct the hive or can be configured as an automated system that controls and instructs the hive at following a human command. In at least one embodiment, the central server comprises an artificially intelligent device that plans and executes missions based on perceived patterns in hive operation or by identifying a need for missions. Accordingly, the central server can be configured as a human-controlled device, automated system, or artificially intelligent system, or a combination thereof.

Additionally, in at least one embodiment, the UAVs receive their instructions from a wireless communication method rather than from being hardwired to the central server as shown in FIG. 1. The wireless communication method should be understood to be any type of communication that is wireless such as radio, infrared, wi-fi, satellite, and Bluetooth communications.

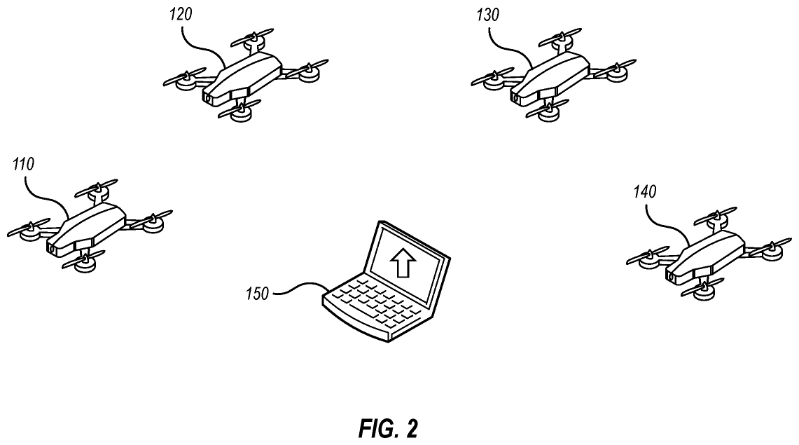

FIG. 2 depicts one or more UAV(s) (110, 120, 130, and 140) receiving a command from the central server 150 to deploy for data collection. In at least one embodiment, the UAVs (110, 120, 130, and 140) are assigned a task for specific data collection and are deployed after receiving the instructions governing safe transmission of data. Deploying the UAVs may include issuing a deployment command. The deployment command can include a mission objective or tasks that need to be completed by the hive. The deployment command, as depicted in FIG. 2, can be relayed to the UAVs (110, 120, 130, and 140) from the central server through wired or wireless data transmissions, such as radio, infrared, wi-fi, satellite, and Bluetooth communications.

In some embodiments, once the deployment command has been assigned to the hive of UAVs, each UAV is in control of its own individual flight path and tasks required to complete each mission. That is, once the UAV has received the instructions and the deployment command, the UAV becomes autonomous in the completion of the mission designated by the deployment command. Flying autonomously may permit each UAV in the hive to be free from a network connection that could potentially be used by unauthorized parties to geolocate the UAV.

In alternative embodiments, the UAV flight path and sensors may be partially controlled from a controller remotely when in a safe zone. The controller may be a human or a machine that uses the onboard controls to navigate the UAV through a mission. In this embodiment, the UAV could continuously check to identify if the UAV is in a safe zone of communication. If the UAV is determined it is not in a safe zone, the UAV could cut off communication with the central server and continues the mission according to the deployment command and the commands from the controller prior to the communication break.

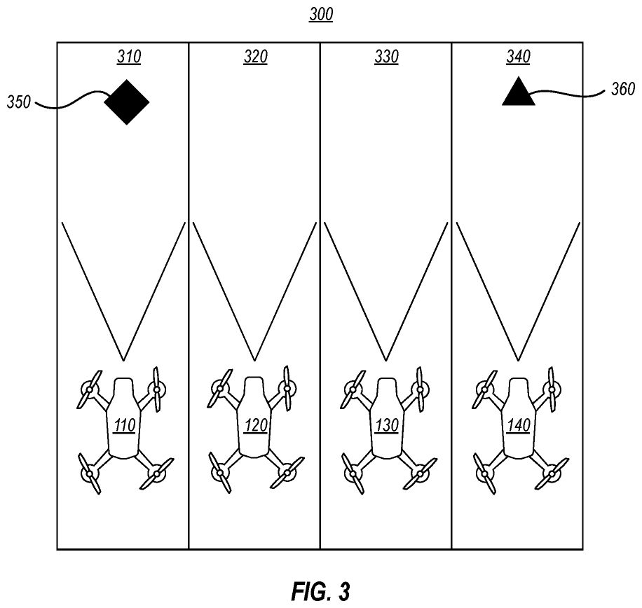

FIG. 3 depicts a hive of UAVs (110, 120, 130, and 140) that have been deployed on a mission to collect data. In at least one embodiment, after deployment and/or during deployment, the UAVs (110, 120, 130, and 140) share data with each other. In some embodiments, each UAV is configured to directly communicate with each of the rest of the UAVs. In some embodiments, each of the UAVs is configured to communicate with each other via the central server. In some embodiments, the UAVs are configured to form an ad hoc network, and each of the UAVs is configured to communicate with the rest of the UAVs via one or more hops of the ad hoc network. Each hop is a communication link directly connecting two nearby UAVs. As such, in the ad hoc network, the nearby UAVs are configured to directly communicate with each other, and the further apart UAVs are configured to communicate with each other via intermediate UAVs.

In the depicted examples, each of the UAVs (110, 120, 130, and 140) within the hive are sent to a particular area (310, 320, 330, and 340) within a geographical field 300. Additionally, the UAVs are tasked with finding objects (350 and 360) within the geographical field 300. In the illustrated embodiment, the UAVs (110, 120, 130, and 140) do not communicate within the hive until a specific reason to communicate has been identified.

In some embodiments, each of the UAVs within the hive is tasked to survey a different subarea of the geographical field to identify one or more objects. In some embodiments, each of the UAVs within the hive is tasked to survey the same geographical field to identify different objects. Once the UAVs (110 and 140) have found their respective objects (350 and 360), the UAVs (110 and 140) begin their transmission check to determine if they are in a safe zone. In FIG. 3, the UAVs (110, 120, 130, and 140) have received a map of predetermined safe zones, where areas 310, 320, and 330 are all classified as safe zones. In contrast, area 340 is classified as an unsafe zone according to the received instructions. Accordingly, UAVs 110, 120, and are able to freely transmit at any time during their search. UAV 140, however, is prevented from transmitting during its search. In such a circumstance, UAV 140 may be configured to move out of the unsafe area 340 or move into a safe zone. When UAV 140 moves out of the unsafe area 340 or move into a safe zone, UAV 140 may then transmit the information about object 360 to the central server 150 or other UAVs 110, 120, 130. Alternatively, UAV 140 will not be allowed to transmit data until it is returned back to a base station after the mission.

In at least one embodiment, while UAV 140 is not allowed to transmit during its search, it is able to receive transmissions. Accordingly, UAV 140 may be receiving the transmissions from UAVs 110, 120, and/or 130. Such a configuration may be useful because UAV 140 may be notified once UAV 110 finds object 350. Upon receiving that notification, UAV 140 may be aware that only a single object 360 remains unaccounted for. Using this information, UAV 140 may be configured to terminate its search once it finds object 360, knowing that it is not necessary to continue searching area 340 for object 350 because it has already been found by UAV 110.

One will appreciate that when searching for an object, a UAV can use a variety of different sensor types. In some embodiments, a UAV can use infrared sensors, sonar sensors, computer vision technology, radar, and other sensor types to find objects. The UAV sensors can also be used to create topographical maps, capture videos, and any other function UAVs can be used for.

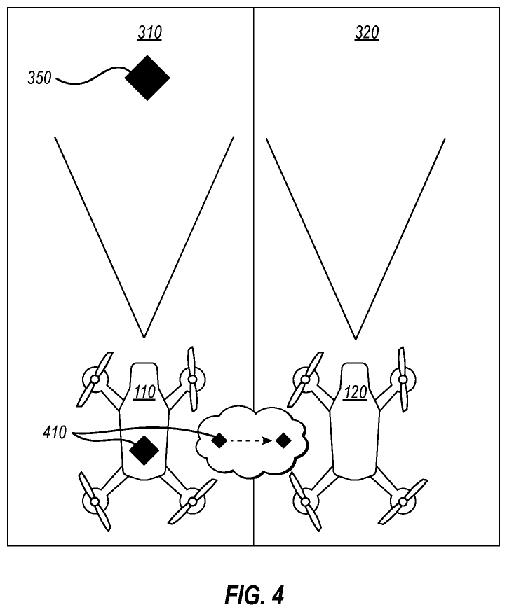

FIG. 4 illustrates a subset of the UAVs (110 and 120) from FIG. 1 deployed on the mission, as seen in FIG. 3. In FIG. 4, a period of time has passed, and a UAV 110 has identified an object 350 and determined a need for the UAV 110 to transmit the collected data 410 to one or more UAV(s) 120. To complete the transmission, the current location of the transmitting UAV 110 is identified. Following the location identification of the UAV 110, a comparison between the current location of the transmitting UAV 110 and the instruction from the central server 150 of FIG. 1 is performed. In some embodiments, like the embodiment illustrated, the instruction comprises a map with pre-designated safe zones. In FIG. 4, UAV 110 is in area 310, which, according to the map, is a pre-designated safe zone. Because the location of the UAV 110 is in a location that has been pre-designated as safe by the instructions from the central server 150 from FIG. 1, the transmission of the data 410 is allowed, and UAV 110 can transmit the data 410 to UAV 120.

In at least one embodiment, a UAV may transmit data for reasons other than identifying a target object (e.g., 350, 360). For example, if a hive is deployed on a mission where each UAV is assigned to observe a segment of an area, once a UAV has completed the observation of the UAV's designated area, the UAV may identify the need to transmit the results of the observation or merely signal to the other UAVs that the UAV has completed the UAV's mission objective.

In some embodiments, the transmission of data occurs when the instructions from the central server need to be updated. The central server 150 may or may not be in communication with the hive after the hive has been deployed. In embodiments where the central server 150 is not in communication with the hive after deployment, the central server 150 may need to update the instructions through a chain method of communication. The chain method of communication includes the central server 150 sending the data to be distributed to one or more UAV(s) that either were previously deployed and in contact with the central server or were deployed with the express purpose of enabling the chain communication. A UAV (e.g., 110) with the communication from the central server 150 then locates one or more UAV(s) (e.g., 120, 130) already deployed to relay the message from the central server 150. Once the message has been relayed, the UAV (e.g., 110) that delivered the data may either continue to share the communication with another UAV (e.g., UAV 140) or may return to the central server 150. The UAV (e.g., UAV 120) that received the communication, updates the instructions or mission objective and commands within the UAV's system and then can either proceed with the mission in light of the new communication from the central server or can pass along the communication to other UAVs (e.g., UAV 140) in the hive within the communication range or can be contacted.

To pass along the communication from the central server 150, the UAV (e.g., 110) completes the data transmission check to determine if the transmission is safe at the UAV's current location. If the transmission is determined not to be safe, the UAV (e.g., 110) does not transmit the data and may wait until the UAV (e.g., 110) is in a location in which it is safe to transmit the data before passing along the communication. When waiting for a safe location to transmit the data, the UAV (e.g., 110) may make continuous checks or may check for a safe zone at time intervals. Once it is safe for the UAV (e.g., 110) to transmit the communication from the central server, the UAV (e.g., 110) may pass along the information to other members of the hive. The other hive UAV (e.g., 120) may, in turn, pass along the information in the same, safe manner as the first UAV (e.g., 110) until all of the UAVs in the hive have received the communication from the central server.

Transmission of data can occur in any way that data can be transmitted. Examples include, but are not limited to, sound transmission and variable strength waves. Sound transmission could include the first UAV (e.g., 110) which is transmitting data, releasing sounds at various frequencies which the receiving UAV (e.g., 120) is able to interpret. The interpretation could occur with a pre-set communication key, such that only the UAVs in the hive could interpret the sounds by the order in which they are transmitted. Transmission could also occur through various strength waves. For example, the transmission could be through infrared waves or could be transmitted through visible light. In some embodiments, the UAV could vary the light according to the amount of distance the data needs to be transmitted or the location of the transmission.

In at least one embodiment, the central server 150 may provide the UAVs 110, 120, 130, 140 with a set of tiered communication and safety levels. For example, in some areas, long-range radio communication may not be allowable, but short-range radio or IR communication may be acceptable. In contrast, in some areas, no level of communication is allowable. In such a configuration, UAV 110 may be able to communicate with UAV 120 using short-range radio communications but not long-range communications. To enable such a function, the UAVs 110, 120, 130, 140 may be programmed to travel to predetermined areas at a predetermined time in order to provide opportunities for the UAVs to be within range of the short-range radio communication.

In contrast, in some embodiments, the UAVs 110, 120, 130, 140 in the hive can only transmit the data back to the central server 150. In such embodiments, when a UAV 110 identifies data that needs to be transmitted, the UAV 110 checks to see if the UAV 110 is in a safe zone of transmission before transmitting the data to the central server. If a UAV 110 needs to transmit data but is too far from the central server 150, the UAV 110 may reroute to be close enough to the central server 150 to transmit the data before proceeding to where the UAV 110 was prior to the reroute. To receive updates to instructions or deployment commands, the UAV 110 may be tasked with returning to a location that makes communication with the central server 150 possible at designated times or using other predetermined triggers to return and receive any communications from the central server.

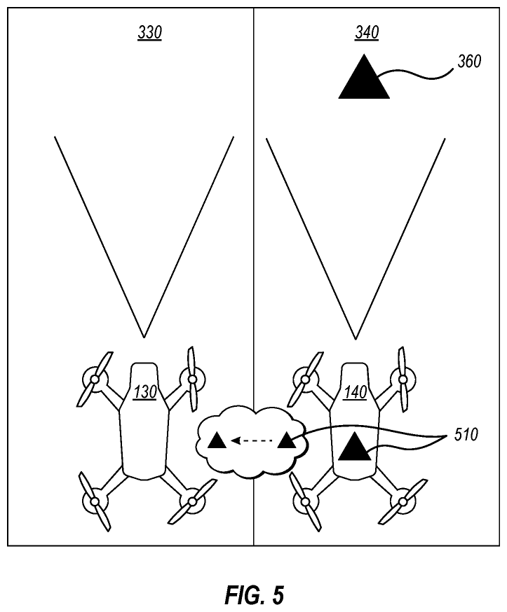

FIG. 5 illustrates a similar situation to FIG. 4. After the time has passed with the UAVs proceeding on a mission, as seen in FIG. 3, a UAV 140 has located an object 360 and has identified a need to transmit the data 510 regarding the object 360 to another UAV 130 in the hive. To begin the transmission process, the UAV 140 checks the current location of the UAV 140 and determines the location resides at a certain point within the area 340. After determining the location of the UAV 140, the UAV 140 checks the instructions given by the central server 150 in FIG. 1. In FIG. 5, the UAV 140 compares the area 340 to the instructions to determine if area 340 is a safe zone for transmitting the data 510 to another UAV 130 in the hive. Unlike the UAV 110 in FIG. 4, the UAV 140 in FIG. 5 is not in a safe zone. The UAV 140 is in area 340 that has not been deemed safe by the instructions. When it is determined that the UAV 140 is in an unsafe zone of communication, such that communicating the collected data 510 would be unsafe, the collected data is prevented from being communicated from one or more UAV(s) 140 to one or more different UAV(s) 130.

In some embodiments, when a UAV 140 starts the transmission checks to determine if a transmission is safe in the UAV's location, the UAV 140 remains in one position. That is, once the UAV 140 starts to determine if it is in a safe zone, rather than continuing to fly and potentially ending up in an unsafe zone between the time the checks are made and the time the transmission of data happens, the UAV stays in one location to ensure safe communication.

In some embodiments, the transmitting UAV 140 checks not only the location of the transmitting UAV 140, but also the location of the intended receiving UAV 130. During the transmission check, the transmitting UAV 140 checks its own location and compares that to the instructions provided from the central server 150. If the comparison yields the result that the transmitting UAV 140 is in a safe zone of communication, rather than just transmitting the data, the transmitting UAV 140 may then send a simple communication asking the receiving UAV 130 if it is safe to receive transmitted data and waits for confirmation before transmitting the data. To be eligible to receive the transmitted data, the receiving UAV 130 must also be in a safe zone. For example, in some embodiments, the simple communication may be a probing message inquiring about a location status of the receiving UAV 130. The receiving UAV 130 goes through the same check as the transmitting UAV 140, first determining the receiving UAV's location and then comparing it against the instructions from the central server. If the receiving UAV 130 is in a safe zone, it signals back to the transmitting UAV 140 that it is eligible to receive the transmission.

Once the transmitting UAV 140 receives the signal that the receiving UAV 130 is also in a safe zone, the transmitting UAV 140 proceeds with the data transmission. If receiving UAV 130 is not in a safe zone, the receiving UAV 130 may either respond with a negative signal or may not respond at all. If the receiving UAV 130 sends a negative signal, the transmitting UAV 140 does not transmit the data. In some embodiments, the transmitting UAV 140 may have a pre-set wait time to receive a signal that the receiving UAV 130 is in a safe zone. If the receiving UAV 130 is not in a safe zone and does not send a signal to the transmitting UAV 140 within a certain period of time, the transmitting UAV 140 assumes the receiving UAV 130 is in an unsafe zone and does not transmit the data. Alternatively, when the receiving UAV 130 is not in a safe zone, the receiving UAV 130 is configured to navigate to a nearby safe zone before performing any communication.

Further, in some embodiments, after the transmitting UAV 140 has received a signal from the receiving UAV 130 that the receiving UAV 130 is in a safe zone, the transmitting UAV 140 checks the space between the transmitting UAV 140 and the receiving UAV 130 to ensure the area which the data transmission will pass-through is also a safe zone. In some situations, the UAVs 130, 140 may be on either side of an unsafe zone. To prevent transmission through an unsafe zone, the transmitting UAV 140, after getting the signal from the receiving UAV 130 that confirms the receiving UAV 130 is in a safe zone, uses properties of the signal to identify on an internal map where the receiving UAV 130 is located. The internal map may be a predetermined map of safe zones given as the instructions by the central server. Once the transmitting UAV 140 identifies where on the predetermined map of safe zones the receiving UAV 130 is located, the transmitting UAV 140 may calculate the direction the transmission of data would travel and check along the path on the map to see if the data transmission would go over any unsafe zone. If the data would travel through an unsafe zone to get from the transmitting UAV 140 to the receiving UAV 130, the transmitting UAV 140 does not transmit data.

Further, in some embodiments, in the event a UAV crashes or is captured by unauthorized sources, the UAV may be equipped to erase all data captured or received and all communications and instructions from the central server. This could include locations of other UAVs in the hive and the central server and the ability to transmit or receive the transmission from other UAVs in the hive.

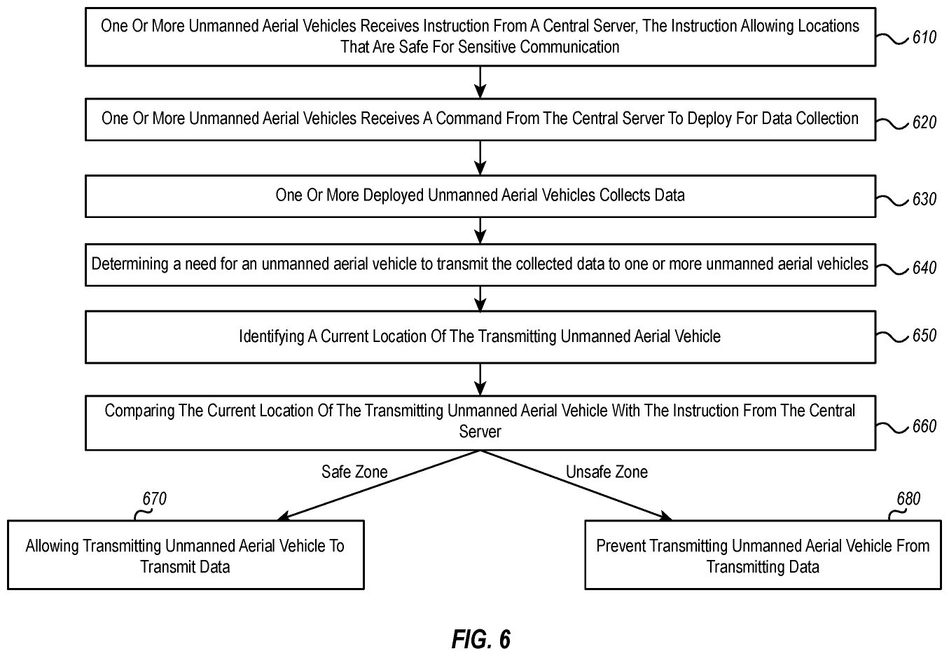

FIG. 6 illustrates a flow chart of the method for safe transmission between two or more UAVs in a hive. For data transmission to occur, the UAVs in the hive may first receive instructions from a central server (act 610). The instructions may contain a predetermined map of safe zones/unsafe zones or decision criteria or other means of instruction to enable the UAV to make real-time judgments about whether the UAV is in a safe or unsafe zone before transmitting data or communicating.

In some embodiments, the one or more criteria is associated with a safe zone or an unsafe zone. For example, the one or more criteria may include (but are not limited to) (1) one or more time intervals within which at least one of the safe zone or unsafe zone is safe or unsafe, (2) one or more objects when detected, indicating at least one of the safe zone or unsafe zone is safe or unsafe, and/or (3) a distance to ground or a landmark with which at least one of the safe zone or unsafe zone is safe or unsafe.

After receiving the instructions from the central server (act 610), the UAV receives a commend from the central server (act 620) requesting the UAV to collect data. The UAV then begins collecting data after being deployed (act 630) based on the command. The data collection can include identifying objects and people, making maps of a geographical location, capturing images or video of objects or people, or any other data collection UAVs can be used for. The command can be simple flight directions or be a detailed mission or a combination.

In some embodiments, the UAV receives the instruction and the command from the central server before it is deployed to a remote area. In some embodiments, the UAV receives the instruction and the command after it has been deployed to a remote area. Alternatively, or in addition, the UAV receives an initial instruction and/or an initial command before it is deployed to a remote area, and receives an updated instruction and/or an updated command after it has been deployed to a remote area. For example, an updated command may indicate the UAV to stop collecting data or start collecting different data.

In some embodiments, the instruction includes a map of an area where the UAVs are deployed or are to be deployed. The map includes (1) one or more geofences indicating one or more safe zones and/or (2) one or more geofences indicating one or more unsafe zones. In some embodiments, the updated instruction includes one or more updated geofences indicating one or more updated safe zones and/or unsafe zones.

During data collection (act 630), one or more of the UAVs may determine a need to transmit data collected during the deployment to one or more of the other UAVs in the hive (act 640). The determination may come from a specific event occurring during the mission, such as observation of a target or important object or completion of a UAVs portion of the mission. The determination may also come from pre-set triggers such as periodic data transmission or distance measurement. Periodic data transmission could include but is not limited to, transmitting data every 15 minutes or a relative time, such as halfway through the mission. Distance measurements could include but are not limited to, transmitting once the UAV has crossed a border or has captured data for 2 miles of terrain.

The one or more UAV(s) are configured to communicate with each other or the central server directly or in directly via wireless communication interfaces and protocols. In some embodiments, each UAV is configured to directly communicate with each of the rest of the UAVs. In some embodiments, each of the UAVs is configured to communicate with each other via the central server. In some embodiments, the UAVs are configured to form an ad hoc network, and each of the UAVs is configured to communicate with the rest of the UAVs via one or more hops of the ad hoc network. Each hop is a communication link directly connecting two nearby UAVs. As such, in the ad hoc network, the nearby UAVs are configured to directly communicate with each other, and the further apart UAVs are configured to communicate with each other via intermediate UAVs.

Following the determination of the need for data transmission from one or more UAV(s) to one or more UAV(s) in the hive (act 640), the one or more UAV(s) identify a current location of the one or more UAV(s) (act 650). Once the location of the one or more UAV(s) has been identified (act 650), one or more UAV(s) compare the location to the instructions received from the central server (act 660). If, according to the comparison, the location of the UAV(s) is in a safe zone, the UAV(s) transmit the data (act 670). If the comparison yields a negative result, such that the UAV(s) is determined to be in an unsafe zone, or not in a safe zone, the UAV(s) refrain from transmitting the data (act 680). In some embodiments, in response to determining that a UAV is in an unsafe zone or is not in a safe zone, the UAV is caused to leave the unsafe zone or move into a safe zone. In response to determining that the UAV is no longer in an unsafe zone or the UAV has entered a safe zone, the UAV is then caused to transmit the collected data.

One will appreciate that the embodiment disclosed herein provide a system for safe data transmission between UAVs in a hive. Such disclosed embodiments allow for data transmission between the UAVs of a hive in safe zones to ensure data transmission between UAVs remains secure.

Further, the methods may be practiced by a computer system, including one or more processors and computer-readable media such as computer memory. For example, each UAV and central server is or includes one or more computer systems having one or more processors and computer-readable media. In particular, the computer-readable media may store computer-executable instructions that, when executed by one or more processors, cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like. Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for secure unmanned aerial vehicle sensitive communication, the method comprising:
receiving, at one or more unmanned aerial vehicles, an instruction from a central server, the instruction at least including (1) one or more safe zones that are safe for sensitive communication between the one or more unmanned aerial vehicles or (2) one or more unsafe zones that are unsafe for sensitive communication;
receiving, at the one or more unmanned aerial vehicles, a command from the central server to cause the one or more unmanned aerial vehicles to collect data;
collecting data, at the one or more unmanned aerial vehicles, based on the command;
determining a need for at least one of the one or more unmanned aerial vehicles to transmit the collected data to at least one other unmanned aerial vehicle or the central server;
identifying a current location of the at least one unmanned aerial vehicle;
determining whether the current location is in a safe zone or an unsafe zone based on the instruction; and
in response to determining that the at least one unmanned aerial vehicle is not in a safe zone, or is in an unsafe zone, preventing the collected data from being transmitted from the at least one unmanned aerial vehicle.

2. The computer-implemented method of claim 1, the method further comprising:
deploying the one or more unmanned aerial vehicles after the one or more unmanned aerial vehicles receive the instruction or the command.

3. The computer-implemented method of claim 2, the method further comprising:
receiving, at the one or more unmanned aerial vehicles, an updated instruction from the central server after the one or more unmanned aerial vehicles have been deployed, the updated instruction indicating (1) one or more updated safe zones that are safe for sensitive communication between the one or more unmanned aerial vehicles or (2) one or more updated unsafe zones that are unsafe for sensitive communication.

4. The computer-implemented method of claim 2, the method further comprising:
receiving, at the one or more unmanned aerial vehicles, an updated command from the central server to collect data, the updated command indicating stopping current data collection or collecting a different type of data indicated in the command that was previously received.

5. The computer-implemented method of claim 1, wherein each of the one or more unmanned aerial vehicles receives a different command from the central server to collect different data.

6. The computer-implemented method of claim 5, wherein each instruction includes a geographic area where an unmanned aerial vehicle is tasked to collect data from, and each of the one or more unmanned aerial vehicles is instructed to collect data from different geographic areas.

7. The computer-implemented method of claim 1, wherein the instruction includes a map of an area where the one or more unmanned aerial vehicles are deployed or are to be deployed, and the map includes one or more geofences indicating one or more safe zones or one or more geofences indicating one or more unsafe zones.

8. The computer-implemented method of claim 1, the method further comprising:
in response to determining that the at least one unmanned aerial vehicle is no longer in an unsafe zone, or enters a safe zone, causing the at least one unmanned aerial vehicle to transmit the collected data.

9. The computer-implemented method of claim 8, the method further comprising:
in response to determining that the at least one unmanned aerial vehicle is not in a safe zone or is in an unsafe zone, causing the at least one unmanned aerial vehicle to move into a safe zone or leave the unsafe zone.

10. The computer-implemented method of claim 1, wherein the instruction further includes one or more criteria associated with the one or more safe zones or unsafe zones, and the one or more criteria includes at least one of (1) one or more time intervals within which at least one of the safe zone or unsafe zone is safe or unsafe, (2) one or more objects when detected, indicating at least one of the safe zone or unsafe zone is safe or unsafe, or (3) a distance to ground or a landmark within which at least one of the safe zone or unsafe zone is safe or unsafe.

11. The computer-implemented method of claim 10, wherein determining whether the at least one unmanned aerial vehicle is in a safe zone or an unsafe zone is further based on the one or more criteria.

12. An unmanned aerial vehicle for collecting data and safe transmission of collected data, comprising:
one or more processors; and
one or more computer-readable media having stored thereon executable instructions that when executed by the one or more processors configure the unmanned aerial vehicle to perform at least:
receive an instruction from a central server, the instruction at least including (1) one or more safe zones that are safe for sensitive communication between the one or more unmanned aerial vehicles or (2) one or more unsafe zones that are unsafe for sensitive communication;
receive a command from the central server to deploy for data collection;
collect data based on the received command;
determine a need for transmitting the collected data to one or more nearby unmanned aerial vehicles or the central server;
identify a current location of itself;
determine whether the current location is in a safe zone or an unsafe zone based on the instruction; and
in response to determining that the current location is not in a safe zone, or is in an unsafe zone, prevent the collected data from being transmitted to one or more nearby unmanned aerial vehicles or the central server.

13. The unmanned aerial vehicle of claim 12, the unmanned aerial vehicle further configured to:
receive an updated instruction from the central server, the updated instruction indicating (1) one or more updated safe zones that are safe for sensitive communication between the one or more unmanned aerial vehicles or (2) one or more updated unsafe zones that are unsafe for sensitive communication.

14. The unmanned aerial vehicle of claim 12, wherein the instruction includes a map of an area where the one or more unmanned aerial vehicles are deployed or are to be deployed, and the map includes one or more geofences indicating one or more safe zones or one or more geofences indicating one or more unsafe zones.

15. The unmanned aerial vehicle of claim 14, the unmanned aerial vehicle further configured to:
in response to determining that itself is no longer an unsafe zone, or enters a safe zone, transmit the collected data to the one or more nearby unmanned aerial vehicles or the central server.

16. The unmanned aerial vehicle of claim 15, the unmanned aerial vehicle further configured to:
in response to determining that itself is not in a safe zone or is in an unsafe zone, move into a safe zone or leave the unsafe zone.

17. The unmanned aerial vehicle of claim 12, wherein the instruction further includes one or more criteria associated with the one or more safe zones or unsafe zones, and the one or more criteria includes at least one of (1) one or more time intervals within which at least one of the safe zone or unsafe zone is safe or unsafe, (2) one or more objects when detected, indicating at least one of the safe zone or unsafe zone is safe or unsafe, or (3) a distance to ground or a landmark within which at least one of the safe zone or unsafe zone is safe or unsafe, and
wherein determining whether itself is in a safe zone or an unsafe zone is further based on the one or more criteria.

18. The unmanned aerial vehicle of claim 12, the unmanned aerial vehicle further configured to:
determine whether a nearby unmanned aerial vehicle is in a safe zone or an unsafe zone; and
in response to determining that itself and the nearby unmanned aerial vehicle are both in a safe zone or not in an unsafe zone, transmit the collected data to the nearby unmanned aerial vehicle.

19. The unmanned aerial vehicle of claim 18, wherein determining whether the nearby unmanned aerial vehicle is in a safe zone or not in an unsafe zone comprises:
sending a probing message to one or more nearby unmanned aerial vehicles inquiring about their location status;
receiving a response from at least one of the one or more nearby unmanned aerial vehicles, indicating that the at least one nearby unmanned aerial vehicle is in a safe zone or not in an unsafe zone; and
determining that the at least one nearby unmanned aerial vehicle is in a safe zone or not in an unsafe zone based on the response.

20. The unmanned aerial vehicle of claim 19, wherein determining whether the nearby unmanned aerial vehicle is in a safe zone or not in an unsafe zone further comprises after sending the probing message, in response to waiting for a predetermined period without receiving a response from the nearby unmanned aerial vehicle, determining that the nearby unmanned aerial vehicle is not in a safe zone or in an unsafe zone; and
wherein in response to determining that the nearby unmanned aerial vehicle is not in a safe zone or in an unsafe zone, refrain from transmitting collected data to the unmanned aerial vehicle.
